(19) United States
(12) Patent Application Publication
(10) Pub. No.: US 2011/0156462 A1
(43) Pub. Date: Jun. 30, 2011

(54) Recliner Assembly For A Vehicle Seat

(75) Inventors: Kung M. Lim, Newmarket (CA); Pius Ng, Markham (CA)

(73) Assignee: Magna Seating Inc., Aurora, ON (CA)

(21) Appl. No.: 13/056,674

(22) PCT Filed: Jul. 30, 2009
(86) PCT No.: PCT/CA2009/001079

§ 371 Date: Jan. 31, 2011

Related U.S. Application Data
(60) Provisional application No. 61/084,744, filed on Jul. 30, 2008.

(51) Int. Cl. B60N 2/22; B60N 2/20

(52) U.S. Cl. 297/354.12

(57) ABSTRACT

A recliner assembly includes first and second disc recliners operatively interconnecting a seat back and seat cushion. A coupling mechanism releasably couples the seat back and the second disc recliner. The coupling mechanism couples the seat back and the second disc recliner together and the first and second disc recliners are selectively actuated between a locked condition and an unlocked condition to pivotally adjust the seat back between a plurality of reclined seating positions. The coupling mechanism uncouples the seat back and the second disk recliner and the first disc recliner is actuated to the unlocked condition to pivot the seat back between a selected one of the plurality of reclined seating positions and forwardly folded position.

### CROSS-REFERENCE TO RELATED APPLICATION

This application claims priority to and all the benefits of U.S. Provisional Application No. 61/084,744, filed on Jul. 30, 2008 and entitled “Recliner Assembly For A Vehicle Seat.”

### BACKGROUND OF THE INVENTION

1. Field of the Invention

The invention relates to a recliner assembly used in an automobile seat for adjustment of a seat back relative to a seat cushion. More particularly, the invention relates to a recliner assembly for a vehicle seat having an easy-entry position and memory return feature.

2. Description of Related Art

Automotive vehicles include seat assemblies for supporting an occupant in the vehicle. The seat assemblies include a generally horizontal seat cushion and a seat back pivotally coupled to the seat cushion by a recliner assembly, allowing pivotal or angular adjustment of the seat back relative to the seat cushion between a plurality of reclined seating positions. Often, the recliner assembly also allows the seat back to pivot forwardly to an easy-entry or dump position to improve ingress and egress to a rear seat or storage area behind the seat assembly. The easy-entry position is defined with the seat back in a forward inclined position.

Disc recliners are well known in the vehicle seating art and are commonly used to pivotally couple the seat back to the seat cushion. Generally, a disc recliner includes a fixed plate adapted to be fixedly secured to the seat cushion and a movable plate adapted to be fixedly secured to the seat back and rotatably coupled to the fixed plate. The disc recliner also includes an internal locking mechanism interconnecting the fixed and movable plates that allows selective pivotal or angular adjustment of the seat back relative to the seat cushion between the plurality of reclined seating positions. Commonly, the internal locking mechanism will also allow pivotal movement of the seat back relative to the seat cushion between any of the reclined seating positions and the easy-entry position.

It is also known that the disc recliner may incorporate a memory feature such that once ingress or egress to the rear seat is no longer desired, the seat back is returned from the easy-entry position to the reclined seating position that was selected immediately prior to moving the seat back to the easy-entry position. Typically, disc recliners with a memory feature are complex and expensive. It is therefore desirable to provide a seat assembly including a recliner assembly for allowing a seat back to move relative to a seat cushion between a plurality of reclined seating positions and an easy-entry position. It is also desirable that the recliner assembly includes a simple memory feature to return the seat back from the easy-entry position to the previous reclined seating position, which is the reclined seating position that was selected immediately prior to moving the seat back to the easy-entry position.

### SUMMARY OF THE INVENTION

According to one aspect of the invention, a recliner assembly for a vehicle seat assembly allows pivotal movement of a seat back relative to a seat cushion between a plurality of reclined seating positions and a forwardly folded position. The recliner assembly includes first and second disc recliners operatively interconnecting the seat back and the seat cushion. The first and second disc recliners are operable between a locked condition and an unlocked condition. A coupling mechanism is operatively coupled between the seat back and the second disc recliner for releasably coupling the seat back and the second disc recliner. Selectively actuating the first and second disc recliners between the locked and unlocked conditions with the seat back coupled with the second disc recliner allows pivotal adjustment of the seat back between the plurality of reclined seating positions. Selectively actuating the first disc recliner to the unlocked condition with the seat back uncoupled with the second disc recliner allows pivotal adjustment of the seat back between a selected one of the plurality of reclined seating positions and the forwardly folded position.

According to another aspect of the invention, a recliner assembly for a vehicle seat assembly allows pivotal movement of a seat back relative to a seat cushion between a plurality of reclined seating positions and a forwardly folded position. The recliner assembly includes first and second disc recliners operatively interconnecting the seat back and the seat cushion. The first and second disc recliners are operable between a locked condition and an unlocked condition. A first coupling mechanism releasably couples the seat back and the first disc recliner and a second coupling mechanism releasably couples the seat back and the second disc recliner. Selectively actuating the first and second disc recliners between the locked and unlocked conditions with the seat back coupled with the first and second disc recliners allows pivotal adjustment of the seat back between the plurality of reclined seating positions. Uncoupling the seat back with the first and second disc recliners allows pivotal adjustment of the seat back between a selected one of the plurality of reclined seating positions and the forwardly folded position.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a rear perspective view of a vehicle seat assembly with a seat back in a reclined seating position and including a recliner assembly according to one embodiment of the invention;

FIG. 2 is a rear perspective view of the vehicle seat assembly in FIG. 1 with the seat back in an easy-entry position;

FIG. 3 is a rear perspective view of the recliner assembly in FIG. 1;

FIG. 4 is an exploded view of the recliner assembly in FIG. 3;

FIG. 5 is an inner perspective view of an inboard side of the recliner assembly in FIG. 3;

FIG. 6 is an outer perspective view of an outboard side of the recliner assembly in FIG. 3;

FIG. 7 is an outer side view of the outboard side of the recliner assembly in FIG. 3;

FIG. 8 is a rear perspective view of a vehicle seat assembly with a seat back in a reclined seating position and including a recliner assembly according to a second embodiment of the invention;

FIG. 9 is a rear perspective view of the vehicle seat assembly in FIG. 8 with the seat back in an easy-entry position;

FIG. 10 is a rear perspective view of the recliner assembly in FIG. 8; and

FIG. 11 is an outer perspective view of an inboard side of the recliner assembly in FIG. 10.

### DETAILED DESCRIPTION OF THE EMBODIMENTS

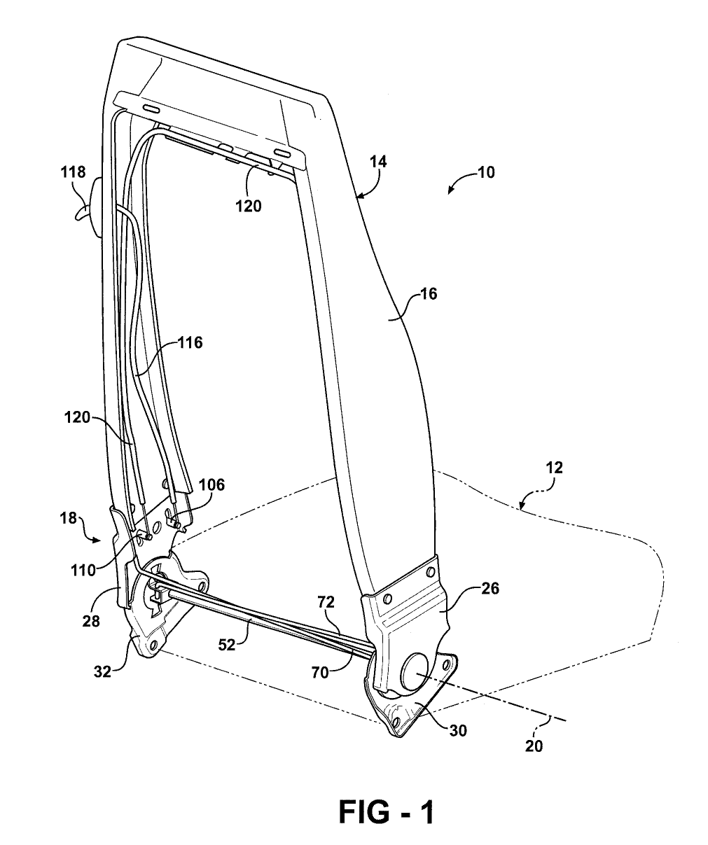

Referring to the Figures, FIG. 1 discloses a seat assembly 10 for use in an automotive vehicle. The seat assembly 10 includes a generally horizontal seat cushion 12 and a seat back 14 for supporting an occupant on the seat assembly 10. The construction of the seat cushion 12 includes a rigid seat cushion frame structure (not shown) for supporting a contoured foam pad encased by a trim cover, as conventionally known to one skilled in the art. Likewise, the construction of the seat back 14 includes a rigid seat back frame structure 16 for supporting a contoured foam pad encased by a trim cover.

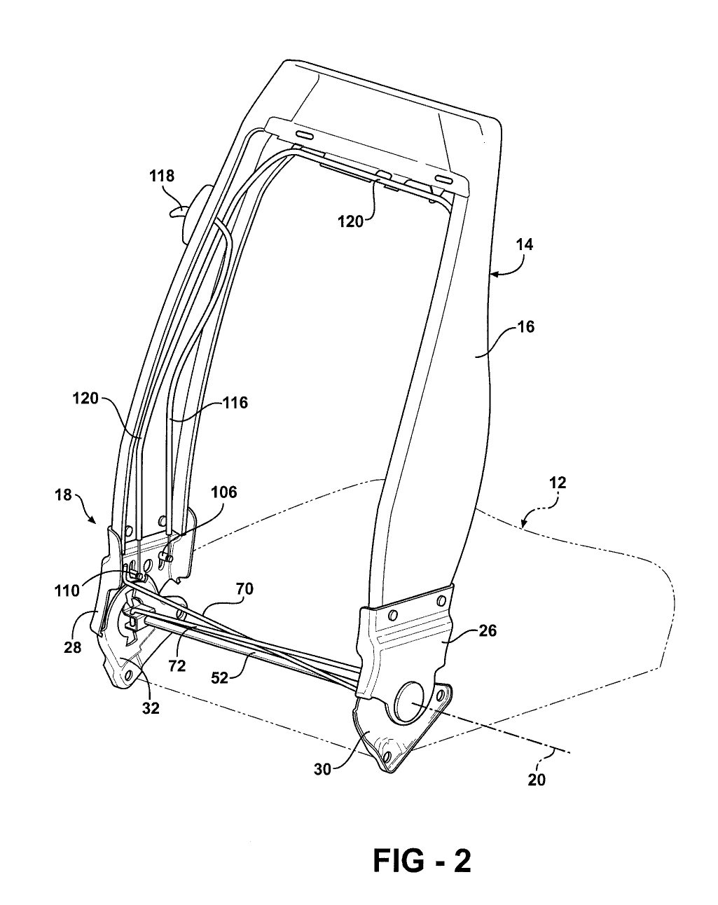

The seat back frame 16 is operatively coupled to the seat cushion frame by a recliner assembly, generally shown at 18. The recliner assembly 18 allows for selective pivotal or angular adjustment of the seat back 14 relative to the seat cushion 12 about a laterally extending pivot axis 20 between an upright seating position and a plurality of reclined seating positions. One of the plurality of reclined seating positions is shown in FIG. 1. The recliner assembly 18 also allows for pivotal movement of the seat back 14 relative to the seat cushion 12 about the pivot axis 20 between any one of the plurality of reclined seating positions and an easy-entry or dump position, shown in FIG. 2. The easy-entry position is defined with the seat back 14 tilted or inclined forwardly relative to the upright seating position. The easy-entry position may be any forwardly folded position without varying from the scope of the invention. After pivoting the seat back 14 to the easy-entry position a memory feature of the recliner assembly 18 ensures the seat back 14 returns to the previous reclined seating position.

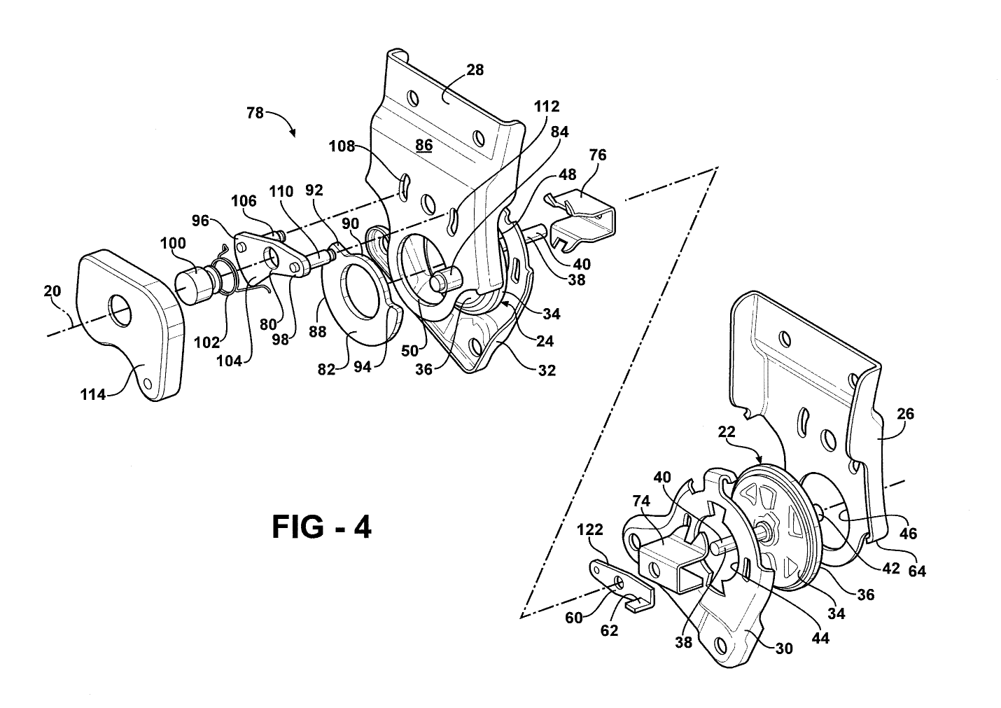

Referring to FIG. 4, the recliner assembly 18 includes an inboard disc recliner 22 and an outboard disc recliner 24. It is understood that inboard and outboard refer to respective sides of the seat assembly 10, however, the relative positions of the inboard and outboard sides of the seat assembly 10 does not limit the scope of the invention. The inboard and outboard disc recliners 22, 24 operatively couple the seat back 14 to the seat cushion 12. More specifically, the seat assembly 10 includes a pair of laterally spaced apart seat back brackets and a pair of laterally spaced apart seat cushion brackets. The seat back brackets include an inboard A-bracket 26 and an outboard A-bracket 28, each of which is fixedly secured to or integrally formed with the seat back frame 16. The seat cushion brackets include an inboard B-bracket 30 and an outboard B-bracket 32, each of which is fixedly secured to or integrally formed with the seat cushion frame. Each of the inboard and outboard disc recliners 22, 24 include a fixed plate 34 and a movable plate 36 rotatably coupled to the fixed plate 34. Referring to the inboard disc recliner 22, the fixed plate 34 is adapted to be fixedly secured to the inboard B-bracket 30 and the movable plate 36 is adapted to be fixedly secured to the inboard A-bracket 26. Referring to the outboard disc recliner 24, the fixed plate 34 is adapted to be fixedly secured to the outboard B-bracket 32 and the movable plate 36 is operatively coupled to the outboard A-bracket 28. The operative connection between the movable plate 36 of the outboard disc recliner 24 and the outboard A-bracket 28 is described below in more detail.

Each of the inboard and outboard disc recliners 22, 24 include a shaft 38 that is co-axial with the pivot axis 20 and extends laterally through the fixed and movable plates 34, 36 between an inner end 40 and an outer end 42. Rotating each shaft 38 actuates the respective inboard and outboard disc recliners 22, 24 between a locked condition and an unlocked condition. In the locked condition, the movable plate 36 is fixed relative to the fixed plate 34. In the unlocked condition, the movable plate 36 is rotatable relative to the fixed plate 34. The inboard and outboard disc recliners 22, 24 are normally in the locked condition.

Referring to the inboard disc recliner 22, the inner end 40 of the shaft 38 extends through an opening 44 in the inboard B-bracket 30 and the outer end 42 of the shaft 38 extends through an opening 46 in the inboard A-bracket 26. Rotation of the shaft 38 in a first direction actuates the inboard disc recliner 22 from the locked condition to the unlocked condition. Referring now to the outboard disc recliner 24, the inner end 40 of the shaft 38 extends through an opening 48 in the outboard B-bracket 32 and the outer end 42 of the shaft 38 extends through an opening 50 in the outboard A-bracket 28. A recliner handle (not shown) is fixedly secured to the outer end 42 of the shaft 38 of the outboard disc recliner 24 for rotating the shaft 38 in the first direction to actuate the outboard disc recliner 24 from the locked condition to the unlocked condition.

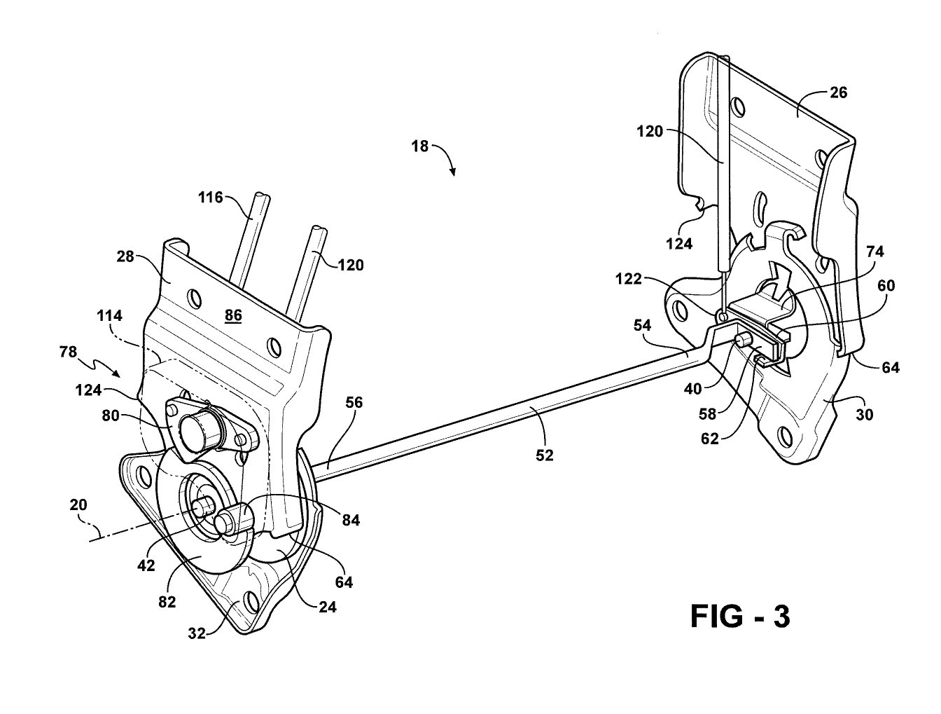

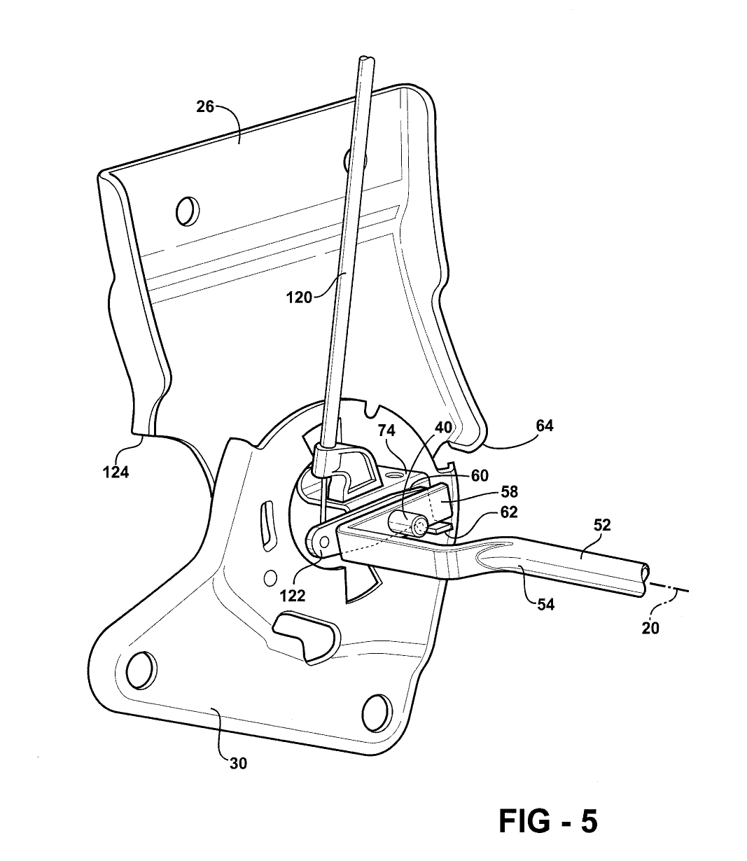

Referring to FIGS. 3 and 5, a cross-talk tube 52 is operatively coupled between the inboard and outboard disc recliners 22, 24 to synchronize actuation thereof. The cross-talk tube 52 is co-axial with the pivot axis 20 and extends laterally between a first end 54 adjacent the inboard disc recliner 22 and a second end 56 adjacent the outboard disc recliner 24. More specifically, the first end 54 includes a lever 58 that is pivotally coupled to the inner end 40 of the shaft 38 of the inboard disc recliner 22. The lever 58 of the cross-talk tube 52 extends generally perpendicular to the pivot axis 20. The second end 56 of the cross-talk tube 52 is fixedly secured to the inner end 40 of the shaft 38 of the outboard disc recliner 24.

A link 60 is fixedly secured to the inner end 40 of the shaft 38 of the inboard disc recliner 22 and extends generally perpendicular to the pivot axis 20. The link 60 is disposed between the inboard B-bracket 30 and the lever 58 at the first end 54 of the cross-talk tube 52. The link 60 includes an arm 62 at one end that is offset from and extends generally parallel to the pivot axis 20. The arm 62 extends in a direction toward the outboard disc recliner 24. When the recliner handle rotates the shaft 38 of the outboard disc recliner 24 and therefore the cross-talk tube 52 in the first direction, the lever 58 at the first end 54 of the cross-talk tube 52 engages the arm 62 of the link 60, thereby rotating the link 60 in the first direction. Rotation of the link 60 in the first direction rotates the shaft 38 of the inboard disc recliner 22 in the first direction. Thus, the inboard and outboard disc recliners 22, 24 are synchronized for simultaneous actuation from the locked condition to the unlocked condition in response to operation of the recliner handle.

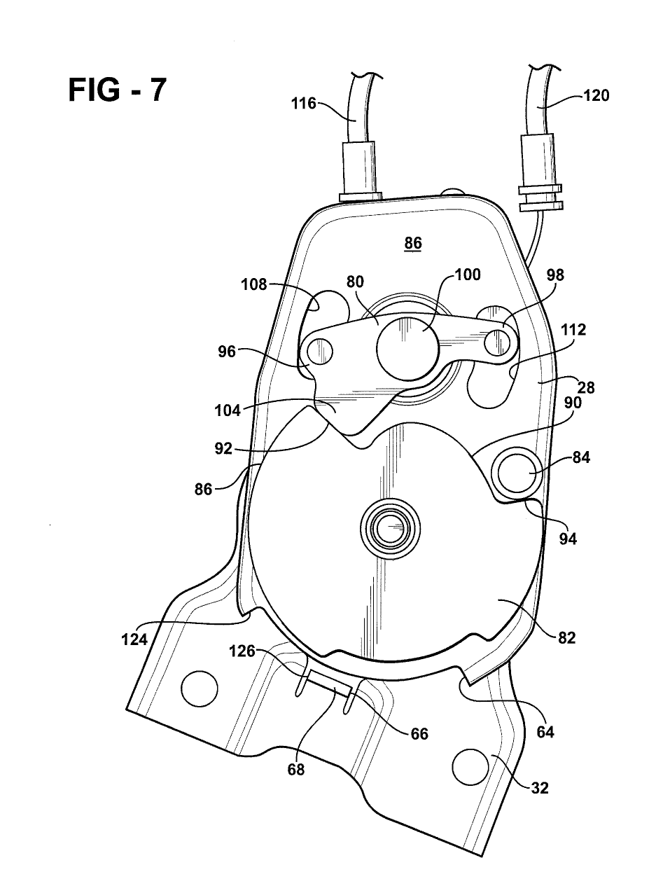

When both the inboard and outboard disc recliners 22, 24 are in the unlocked condition, the seat back 14 is free to pivot between the upright seating position and the plurality of reclined seating positions. The outboard disc recliner 24 includes an internal forward stop (not shown) to define the upright seating position of the seat back 14. More specifically, the internal forward stop prevents the movable plate 36 from rotating relative to the fixed plate 34 at a position of rotation to stop the seat back 14 from pivoting forwardly past the upright seating position. The inboard disc recliner 22 does not include an internal forward stop. Thus, in the unlocked condition, the inboard disc recliner 22 acts as a free pivot. Referring to FIG. 7, a rearward flange 64 on the inboard and outboard A-brackets 26, 28 abuts a rearward edge 66 of a stop tab 68 on the corresponding inboard and outboard B-brackets 30, 32 to define a fully reclined seating position (only the stop tab 68 on the outboard B-bracket 32 side is shown in the Figures).

Referring to FIGS. 1 and 2, the seat back 14 is biased towards the upright seating position by a first torsion bar 70 extending between the seat back frame 16 and the inboard B-bracket 30 and a second torsion bar 72 extending between the seat back frame 16 and the outboard B-bracket 32. More specifically, an inboard mounting bracket 74 is fixedly secured to or integrally formed with the inboard B-bracket 30 and the first torsion bar 70 extends between the inboard mounting bracket 74 and an outboard side of the seat back frame 16. Likewise, an outboard mounting bracket 76 is fixedly secured to or integrally formed with the outboard B-bracket 32 and the second torsion bar 72 extends between the outboard mounting bracket 76 and an inboard side of the seat back frame 16. The first and second torsion bars 70, 72 are twisted or loaded as the seat back 14 is pivotally adjusted rearwardly towards one of the plurality of reclined seating positions. Thus, the first and second torsion bars 70, 72 bias the seat back 14 towards the upright seating position as is well known to one skilled in the art. It is appreciated that other biasing means could be used instead of the first and second torsion bars 70, 72 without varying from the scope of the invention.

Referring to FIGS. 3, 4, 6, and 7, the outboard A-bracket 28 is operatively coupled to the movable plate 36 of the outboard disc recliner 24 by a coupling mechanism, generally shown at 78. When the coupling mechanism 78 is engaged, the outboard A-bracket 28 is coupled to the movable plate 36 of the outboard disc recliner 24. Alternatively, when the coupling mechanism 78 is disengaged, the outboard A-bracket 28 is uncoupled from the movable plate 36 of the outboard disc recliner 24. The coupling mechanism 78 includes a cam 80, a sector 82, and a stop pin 84. The sector 82 is disposed adjacent to an outer side 86 of the outboard A-bracket 28 and is fixedly secured to the movable plate 36 of the outboard disc recliner 24 such that it rotates therewith. More specifically, the sector 82 is welded or staked to the movable plate 36 of the outboard disc recliner 24 through the opening 50 in the outboard A-bracket 28. The sector 82 includes a peripheral edge defining a dump profile 88 and an adjustment profile 90. The adjustment profile 90 is defined by a recessed portion in the dump profile 88 that extends between a forward end 92 and a rearward end 94.

The stop pin 84 is fixedly secured to the outer side 86 of the outboard A-bracket 28 and extends laterally therefrom. The stop pin 84 is adapted for engaging the rearward end 94 of the adjustment profile 90.

The cam 80 extends between a first end 96 and a second end 98 and is pivotally coupled to the outer side 86 of the outboard A-bracket 28 by a cam pivot pin 100 located between the first and second ends 96, 98. A spring 102 biases the first end 96 of the cam 80 in a second direction into engagement with the sector 82. The first end 96 of the cam 80 includes a lobe 104 that is adapted for engaging the forward end 92 of the adjustment profile 90. The first end 96 of the cam 80 also includes a first cable pin 106 extending laterally towards the inboard disc recliner 22 through a first slot 108 in the outboard A-bracket 28. Similarly, the second end 98 of the cam 80 includes a second cable pin 110 extending laterally towards the inboard disc recliner 22 through a second slot 112 in the outboard A-bracket 28. A cover plate 114 is provided for enclosing the cam 80 on the outer side 86 of the outboard A-bracket 28.

When the coupling mechanism 78 is engaged, the lobe 104 on the cam 80 is engaged with or abuts the forward end 92 of the adjustment profile 90 and the stop pin 84 is engaged with or abuts the rearward end 94 of the adjustment profile 90, as shown in FIGS. 3 and 7. In this position, the outboard A-bracket 28 is coupled with or fixedly secured to the sector 82, thereby coupling the outboard A-bracket 28 and the movable plate 36 of the outboard disc recliner 24 together. Thus, when the coupling mechanism 78 is engaged, actuating the inboard and outboard disc recliners 22, 24 to the unlocked condition allows the seat back 14 to pivot between the upright seating position and the plurality of reclined seating positions. Additionally, the engagement between the cam 80 and the sector 82 transfers a forward load on the seat back 14 through the outboard disc recliner 24 to the seat cushion 12. Likewise, the engagement between the stop pin 84 and the sector 82 transfers a rearward load on the seat back 14 through the outboard disc recliner 2 to the seat cushion 12.

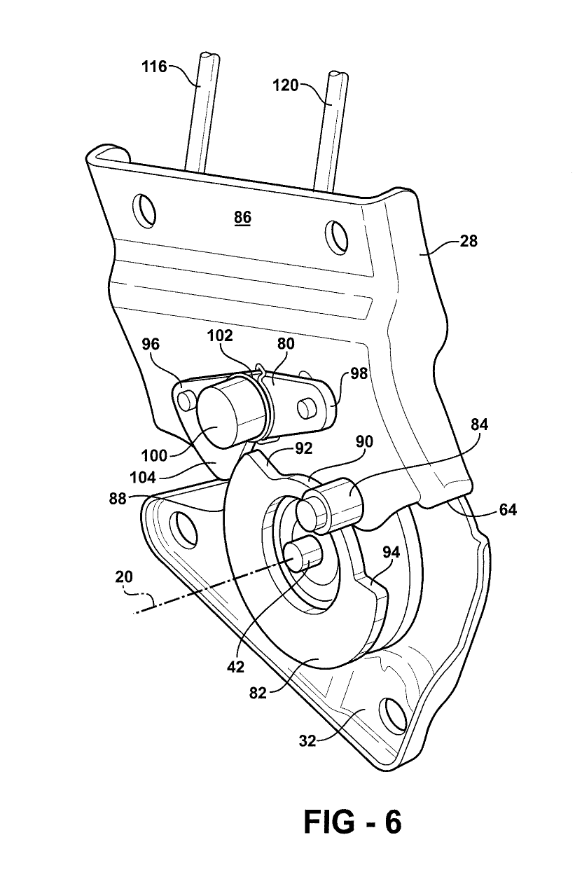

When the coupling mechanism 78 is disengaged, the lobe 104 on the cam 80 is disengaged with the forward end 92 of the adjustment profile 90 such that the outboard A-bracket 28 is free to pivot independently from the sector 82, as shown in FIG. 6. In this position, the outboard A-bracket 28 is uncoupled with the movable plate 36 of the outboard disc recliner 24. Thus, when the coupling mechanism 78 is disengaged, actuating the inboard disc recliner 22 to the unlocked condition allows the seat back 14 to pivot forwardly to the easy-entry position while the outboard disc recliner 24 remains in the locked condition at the position of the previous reclined seating position, which is the reclined seating position that was selected immediately prior to moving the seat back 14 to the easy-entry position. This acts as the memory feature of the recliner assembly 18, which will be described in further detail below.

To disengage the coupling mechanism 78, a first Bowden cable 116 extends between an easy-entry handle 118 and the cam 80. In the embodiment shown, the easy-entry handle 118 is coupled to an upper end of the seat back 14, as is well known in the art. It is appreciated that the easy-entry handle 118 can be located anywhere on the seat assembly 10 without varying from the scope of the invention. One end of the first cable 116 is operatively coupled to the easy-entry handle 118 and another end of the first cable 116 is operatively coupled to the first cable pin 106, as shown in FIGS. 1 and 2. A second Bowden cable 120 extends between the cam 80 and the link 60 fixed to the shaft 38 of the inboard disc recliner 22. One end of the second cable 120 is operatively coupled to the second cable pin 110, shown in FIGS. 1 and 2, and another end of the second cable 120 is operatively coupled to an end 122 of the link 60 that is opposite the end with the arm 62, shown in FIG. 5.

Therefore, operation of the easy-entry handle 118 pulls the first cable 116 and causes the cam 80 to pivot about the cam pivot pin 100 in the first direction to disengage the lobe 104 from the forward end 92 of the adjustment profile 90 of the sector 82. With the lobe 104 disengaged from the forward end 92 of the adjustment profile 90 the outboard disc recliner 24 remains in the locked condition, however, the outboard A-bracket 28 is free to pivot relative to the outboard B-bracket 32. At the same time, pivotal movement of the cam 80 in the first direction pulls the second cable 120 which causes the link 60 to pivot in the first direction. Pivotal movement of the link 60 in the first direction rotates the shaft 38 of the inboard disc recliner 22 in the first direction and actuates the inboard disc recliner 22 to the unlocked condition. With the inboard disc recliner 22 in the unlocked condition the inboard A-bracket 26 is free to pivot relative to the inboard B-bracket 30. Thus, the seat back 14 is free to pivot forwardly towards the easy-entry position. As the seat back 14 pivots forwardly towards the easy-entry position, the lobe 104 rides along the dump profile 88 and the stop pin 84 rides along the adjustment profile 90. A forward flange 124 on the inboard and outboard A-brackets 26, 28 abuts a forward edge 126 on the stop tab 68 on the corresponding inboard and outboard B-brackets 30, 32 to define the easy-entry position of the seat back 14 (only the stop tab 68 on the outboard B-bracket 32 side is shown in the Figures).

In operation, the seat back 14 is normally in one of the plurality of reclined seating positions, shown in FIG. 1, and the coupling mechanism 78 is engaged such that the outboard A-bracket 28 is coupled to the movable plate 36 of the outboard disc recliner 24. When it is desired to adjust the seat back 14 between the plurality of reclined seating positions, the recliner handle is operated to rotate the shaft 38 of the outboard disc recliner 24 in the first direction. Rotating the shaft 38 of the outboard disc recliner 24 in the first direction actuates the outboard disc recliner 24 to the unlocked condition. At the same time, the cross-talk tube 52 rotates in the first direction such that the lever 58 at the first end 54 engages the arm 62 of the link 60 and rotates the shaft 38 of the inboard disc recliner 22 in the first direction. Rotating the shaft 38 of the inboard disc recliner 22 in the first direction actuates the inboard disc recliner 22 to the unlocked condition. Thus, with both the inboard and outboard disc recliners 22, 24 in the unlocked condition, the seat back 14 can be pivotally adjusted between any of the plurality of reclined seating positions that lie between the upright seating position and the fully reclined seating position.

When it is desired to pivot the seat back 14 forwardly to the easy-entry position, shown in FIG. 2, the easy-entry handle 118 is operated to pull the first cable 116. Pulling the first cable 116 pivots the cam 80 in the first direction to disengage the lobe 104 from the forward end 92 of the adjustment profile 90 of the sector 82 to uncouple the outboard A-bracket 28 from the movable plate 36 of the outboard disc recliner 24. At the same time, the cam 80 pulls the second cable 120 and causes the link 60 to rotate the shaft 38 of the inboard disc recliner 22 in the first direction, which actuates the inboard disc recliner 22 to the unlocked condition. Thus, with the outboard A-bracket 28 free to pivot relative to the outboard B-bracket 32 and the inboard disc recliner 22 in the unlocked condition, the seat back 14 can be pivoted forwardly towards the easy-entry position. As the seat back 14 pivots forwardly, the lobe 104 on the cam 80 rides along the dump profile 88 of the sector 82 and the stop pin 84 rides along the adjustment profile 90 of the sector 82 until the forward flange 124 on the inboard and outboard A-brackets 26, 28 abuts the forward edge 126 of the stop tab 68 on the inboard and outboard B-brackets 30, 32 and the seat back 14 is in the easy-entry position.

When it is desired to return the seat back 14 from the easy-entry position, the memory feature of the recliner assembly 18 will ensure that the seat back 14 returns to the previous reclined seating position, which is the reclined seating position that was selected immediately prior to moving the seat back 14 to the easy-entry position. The memory feature is provided by the operation of the recliner assembly 18. When the seat back 14 is pivoted to the easy-entry position, the outboard A-bracket 28 is uncoupled from the movable plate 36 of the outboard disc recliner 24 and the outboard disc recliner 24 remains in the locked condition at the position of the previous reclined seating position. Thus, as the seat back 14 pivots rearwardly, the lobe 104 on the cam 80 rides along the dump profile 88 of the sector 82 and the stop pin 84 rides along the adjustment profile 90 of the sector 82 until the stop pin 84 engages the rearward end 94 of the adjustment profile 90. The spring 102 then biases the cam 80 to pivot in the second direction to engage the lobe 104 with the forward end 92 of the adjustment profile 90, which in turn couples the outboard A-bracket 28 and the movable plate 36 of the outboard disc recliner 24 together. At the same time, the pivotal movement of the cam 80 in the second direction releases the second cable 120, which allows an internal biasing mechanism to actuate the inboard disc recliner 22 to the locked condition. The seat back 14 is now in the previous reclined seating position and the inboard and outboard disc recliners 22, 24 can once again be actuated to adjust the seat back 14 between the plurality of reclined seating positions.

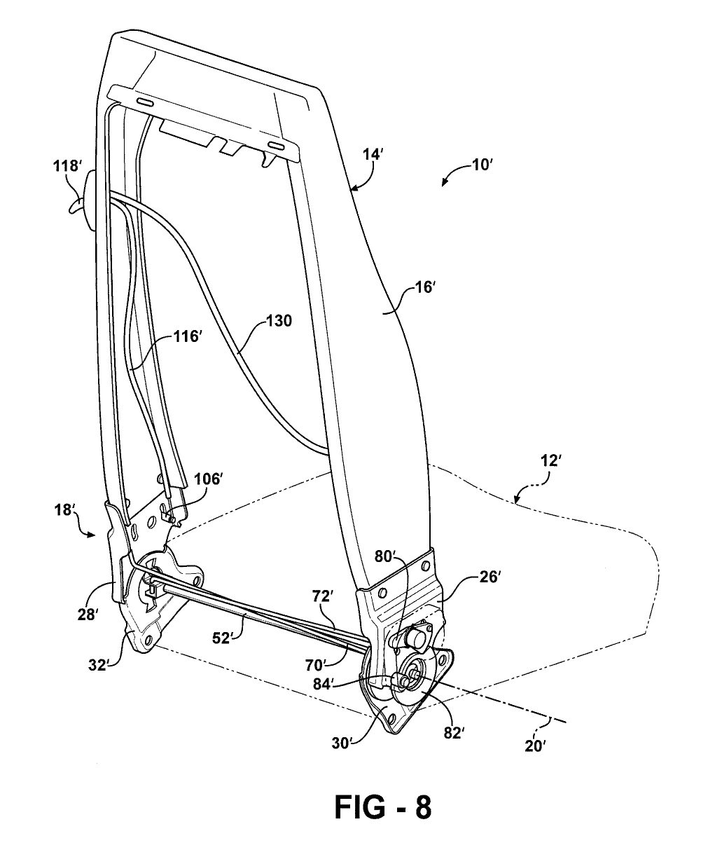

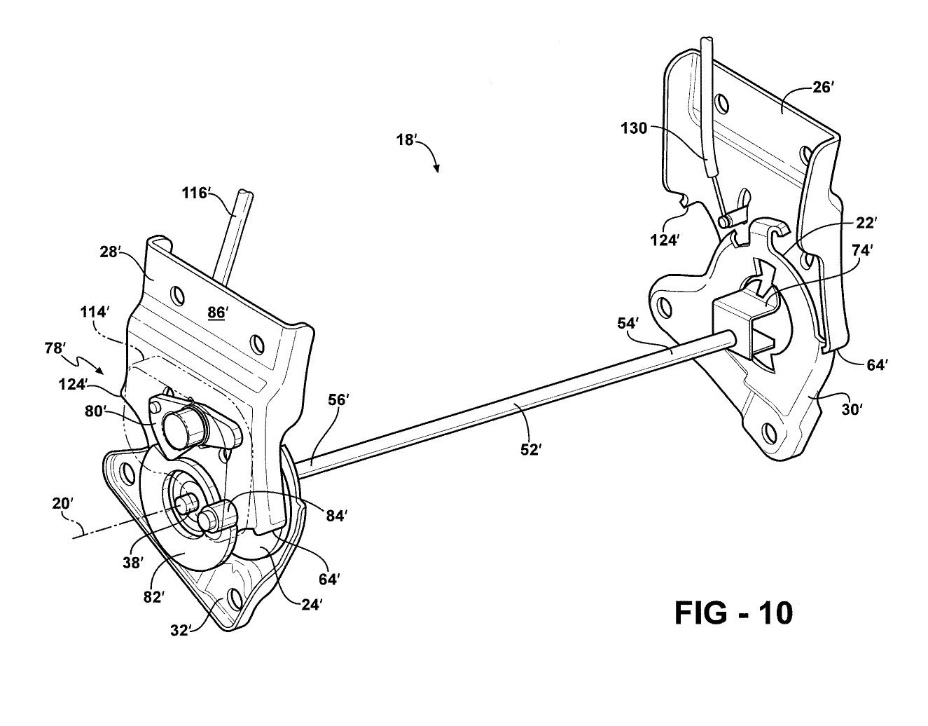

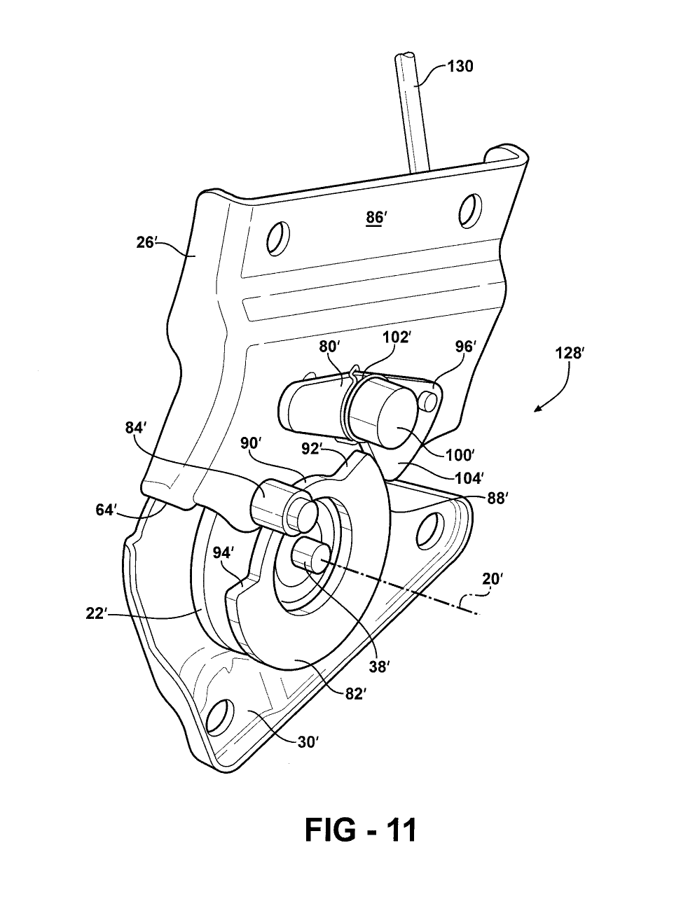

Referring to FIGS. 8 through 11, wherein like primed reference numerals represent similar elements as those described above, in a second embodiment of the invention a seat assembly 10′ includes a recliner assembly 18′ having an inboard disc recliner 22′ and an outboard disc recliner 24′ that are directly coupled together with a cross-talk tube 52′ to synchronize actuation thereof. The cross-talk tube 52′ is co-axial with a pivot axis 20′ of a seat back 14′ and extends laterally between a first end 54′ fixedly secured to an inner end of a shaft 38′ of the inboard disc recliner 22′ and a second end 56′ fixedly secured to the inner end of the shaft 38′ of the outboard disc recliner 24′. Thus, the inboard and outboard disc recliners 22′, 24′ are synchronized for simultaneous actuation from a locked condition to an unlocked condition in response to operation of a recliner handle for pivotal movement of the seat back 14′ about the pivot axis 20′ between an upright seating position and a plurality of reclined seating positions.

In the second embodiment of the invention, an inboard A-bracket 26′ is operatively coupled to a movable plate of the inboard disc recliner 22′ by a first coupling mechanism 128 and an outboard A-bracket 28′ is operatively coupled to a movable plate of the outboard disc recliner 24′ by a second coupling mechanism 78′. The first and second coupling mechanisms 128, 78′ are substantially the same and include a cam 80′, a sector 82′, and a stop pin 84′. When the first and second coupling mechanisms 128, 78′ are engaged, the inboard and outboard A-brackets 26′, 28′ are coupled to the movable plate of the respective inboard and outboard disc recliners 22′, 24′. Alternatively, when the first and second coupling mechanisms 128, 78′ are disengaged, the inboard and outboard A-brackets 26′, 28′ are uncoupled from the movable plate of the respective inboard and outboard disc recliners 22′, 24′.

Also in the second embodiment of the invention, the second Bowden cable 120 has been removed. As in the first embodiment, a first Bowden cable 116′ is provided for disengaging the second coupling mechanism 78′ to uncouple the outboard A-bracket 28′ and the movable plate of the outboard disc recliner 24′. Similarly, a third Bowden cable 130 is provided for disengaging the first coupling mechanism 128 to uncouple the inboard A-bracket 26′ and the movable plate of the inboard disc recliner 22′. The third cable 130 extends between an easy-entry handle 118′ and a first cable pin 106′ on a first end 96′ of the cam 80′ of the first coupling mechanism 128. Therefore, operation of the easy-entry handle 118′ pulls the first and third cables 116′, 130 to uncouple the inboard and outboard A-brackets 26′, 28′ with the movable plate of the respective inboard and outboard disc recliners 22′, 24′ such that the inboard and outboard A-brackets 26′, 28′ are free to pivot relative to inboard and outboard B-brackets 30′, 32′. Thus, the seat back 14′ is free to pivot forwardly toward an easy-entry position. The inboard and outboard disc recliners 22′, 24′, however, remain in the locked condition.

In operation, the seat back 14′ is normally in one of a plurality of reclined seating positions, shown in FIG. 8, and both the first and second coupling mechanisms 128, 78′ are engaged such that the inboard and outboard A-brackets 26′, 28′ are coupled to the movable plate of the respective inboard and outboard disc recliners 22′, 24′. When it is desired to adjust the seat back 14′ between the plurality of reclined seating positions, the recliner handle is operated to rotate the shaft 38′ of the outboard disc recliner 24′ in a first direction. Rotating the shaft 38′ of the outboard disc recliner 24′ in the first direction actuates the outboard disc recliner 24′ to the unlocked condition. At the same time, the cross-talk tube 52′ rotates in the first direction and rotates the shaft 38′ of the inboard disc recliner 22′ in the first direction. Rotating the shaft 38′ of the inboard disc recliner 22′ in the first direction actuates the inboard disc recliner 22′ to the unlocked condition. Thus, with both the inboard and outboard disc recliners 22′, 24′ in the unlocked condition, the seat back 14′ can be pivotally adjusted between any of the plurality of reclined seating positions that lie between the upright seating position and a fully reclined seating position.

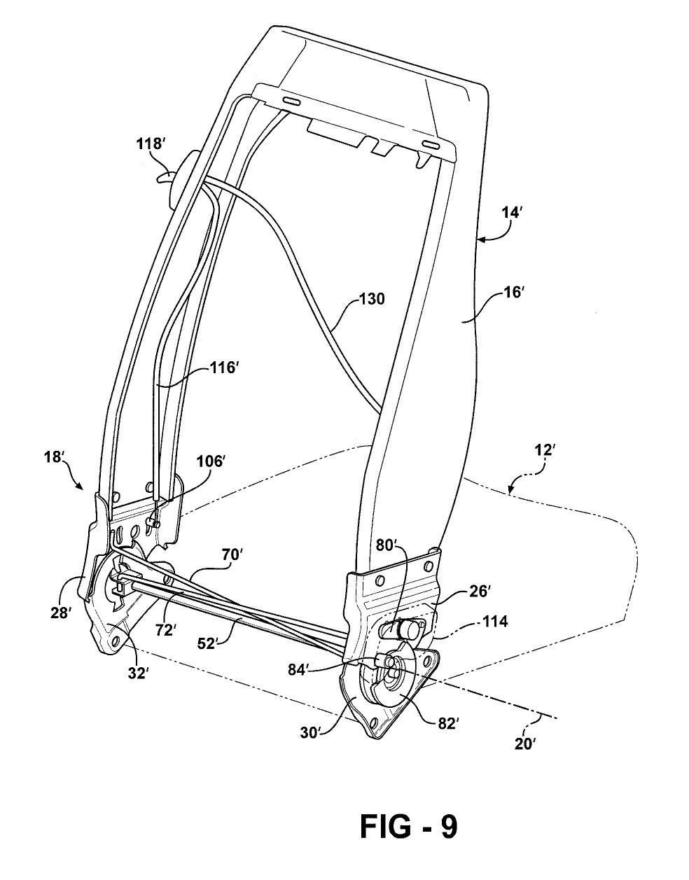

When it is desired to pivot the seat back 14′ forwardly to the easy-entry position, shown in FIG. 9, the easy-entry handle 118′ is operated to pull the first and third cables 116′, 130. Pulling the first and third cables 116′, 130 uncouples the inboard and outboard A-brackets 26′, 28′ with the movable plate of the respective inboard and outboard disc recliners 22′, 24′ such that the inboard and outboard A-brackets 26′, 28′ are free to pivot relative to the inboard and outboard B-brackets 30′, 32′. Thus, the seat back 14′ is free to pivot forwardly toward the easy-entry position. The inboard and outboard disc recliners 22′, 24′, however, remain in the locked condition and act as a memory feature to ensure that the seat back 14′ will return to the previous reclined seating position, which is the reclined seating position that was selected immediately prior to moving the seat back 14′ to the easy-entry position. The memory feature is provided by the operation of the recliner assembly 18′. When the seat back 14′ is pivoted to the easy-entry position, the inboard and outboard A-brackets 26′, 28′ are uncoupled from the movable plate of the respective inboard and outboard disc recliners 22′, 24′ and the inboard and outboard disc recliners 22′, 24′ remain in the locked condition at the position of the previous reclined seating position. Thus, as the seat back 14′ pivots rearwardly, the first and second coupling mechanisms 128, 78′ re-couple the inboard and outboard A-brackets 26′, 28′ with the movable plate of the respective inboard and outboard disc recliners 22′, 24′ when the seat back 14′ is in the previous reclined seating position. Then, the inboard and outboard disc recliners 22′, 24′ can once again be actuated to adjust the seat back 14′ between the plurality of reclined seating positions.

The invention has been described here in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated within the description.

What is claimed:

1. A vehicle seat assembly, comprising:
a seat cushion;
a seat back operatively coupled to said seat cushion for pivotal movement of said seat back between a plurality of reclined seating positions and a forwardly folded position;
a first disc recliner operatively interconnecting said seat back and said seat cushion, said first disc recliner operable between a locked condition and an unlocked condition;
a second disc recliner operatively interconnecting said seat back and said seat cushion, said second disc recliner operable between a locked condition and an unlocked condition; and
a coupling mechanism releasably coupling said seat back and said second disc recliner, wherein selectively actuating said first and second disc recliners between said locked and unlocked conditions with said seat back coupled with said second disc recliner allows pivotal adjustment of said seat back between said plurality of reclined seating positions, and wherein selectively actuating said first disc recliner to said unlocked condition with said seat back uncoupled with said second disc recliner allows pivotal adjustment of said seat back between a selected one of said plurality of reclined seating positions and said forwardly folded position.

2. A recliner assembly as set forth in claim 1 wherein said coupling mechanism automatically re-couples said seat back and said second disc recliner in response to returning said seat back from said forwardly folded position to said selected one of said plurality of reclined seating positions.

3. A vehicle seat assembly, comprising:
a seat cushion;
a seat back operatively coupled to said seat cushion for pivotal movement of said seat back between a plurality of reclined seating positions and a forwardly folded position;
a first disc recliner coupled between said seat back and said seat cushion, said first disc recliner operable between a locked condition and an unlocked condition; and
a second disc recliner coupled with said seat cushion and releasably coupled with said seat back, said second disc recliner operable between a locked condition and an unlocked condition;
wherein said second disc recliner is coupled with said seat back and said first and second disc recliners are selectively actuated between said locked and unlocked conditions to pivotally adjust said seat back between said plurality of reclined seating positions, and wherein said second disc recliner is uncoupled with said seat back and remains in said locked condition and said first disc recliner is actuated to said unlocked condition to pivot said seat back between a selected one of said plurality of reclined seating positions and a forwardly folded position.

4. A recliner assembly as set forth in claim 3 wherein said first and second disc recliners are operatively coupled together and actuation of said second disc recliner from said locked condition to said unlocked condition simultaneously actuates said first disc recliner from said locked condition to said unlocked condition.

5. A recliner assembly as set forth in claim 4 including a coupling mechanism releasably coupling said seat back and said second disc recliner, wherein said coupling mechanism and said first disc recliner are operatively coupled together such that uncoupling said seat back and said second disc recliner simultaneously actuates said first disc recliner from said locked condition to said unlocked condition.

6. A recliner assembly as set forth in claim 5 wherein said coupling mechanism includes a cam and a stop pin coupled to said seat back and a sector coupled to said second disc recliner, wherein said cam and said stop pin engage with said sector thereby coupling said seat back and said second disc recliner, and wherein said cam is operable to partially disengage with said sector thereby uncoupling said seat back and said second disc recliner.

7. A recliner assembly as set forth in claim 6 wherein said cam is pivotally coupled to said seat back, said stop pin is fixedly secured to said seat back and said sector is fixedly secured to said second disc recliner, said sector including a periphery defining a dump profile and an adjustment profile, wherein said cam and said stop pin engage with said adjustment profile thereby coupling said seat back and said second disc recliner, and wherein said cam pivots to disengage with said adjustment profile and engage with said dump profile thereby uncoupling said seat back and said second disc recliner.

8. A recliner assembly as set forth in claim 7 wherein said adjustment profile extends between a forward end and a rearward end, said cam engaging said forward end and said stop pin abutting said rearward end thereby coupling said seat back and said second disc recliner, and said cam engaging said dump profile and said stop pin engaging said adjustment profile thereby uncoupling said seat back and said second disc recliner.

9. A recliner assembly as set forth in claim 8 wherein said first disc recliner includes a first fixed plate adapted to be fixedly secured to said seat cushion and a first movable plate adapted to be fixedly secured to said seat back and rotatably coupled to said first fixed plate, and said second disc recliner includes a second fixed plate adapted to be fixedly secured to said seat cushion and a second movable plate adapted to be operatively coupled to said seat back and rotatably coupled to said second fixed plate.

10. A recliner assembly as set forth in claim 9 wherein said sector is fixedly secured to said second movable plate.

11. A recliner assembly as set forth in claim 10 wherein said first disc recliner includes a laterally extending first shaft for actuating said first disc recliner between said locked and unlocked conditions in response to rotation of said first shaft, and said second disc recliner includes a laterally extending second shaft for actuating said second disc recliner between said locked and unlocked conditions.

12. A recliner assembly as set forth in claim 11 further including a cross-talk tube fixedly secured to said second shaft and operatively coupled to said first shaft, wherein rotation of said second shaft in a first direction actuates said second disc recliner from said locked condition to said unlocked condition and in response to rotation of said second shaft in said first direction said first shaft rotates in said first direction thereby actuating said first disc recliner from said locked condition to said unlocked condition, and wherein independent rotation of said first shaft in said first direction actuates said first disc recliner from said locked condition to said unlocked condition without rotating said second shaft thereby maintaining said second disc recliner in said locked condition.

13. A recliner assembly as set forth in claim 12 further including a link fixedly secured to said first shaft having an arm extending generally parallel to said cross-talk tube, said cross-talk tube including a lever extending generally perpendicular to said cross-talk tube, said lever pivotally coupled to said first shaft, wherein said lever engages said arm to rotate said first shaft in said first direction in response to rotation of said second shaft in said first direction, and wherein said arm disengages with said lever to prevent rotation of said second shaft in said first direction in response to independent rotation of said first shaft in said first direction.

14. A recliner assembly as set forth in claim 13 further including a first cable operatively coupled to said cam for pivoting said cam to disengage with said adjustment profile thereby uncoupling said seat back and said second disc recliner and a second cable operatively coupled between said cam and said link for rotating said link to independently rotate said first shaft in said first direction without rotating said second shaft thereby maintaining said second disc recliner in said locked condition.

15. A vehicle seat assembly, comprising:
a seat cushion;
a seat back operatively coupled to said seat cushion for pivotal movement of said seat back relative to said seat cushion between a plurality of reclined seating positions and a forwardly folded position;
a first disc recliner operatively interconnecting said seat back and said seat cushion, said first disc recliner operable between a locked condition and an unlocked condition;
a second disc recliner operatively interconnecting said seat back and said seat cushion, said second disc recliner operable between a locked condition and an unlocked condition;
a first coupling mechanism releasably coupling said seat back and said first disc recliner; and
a second coupling mechanism releasably coupling said seat back and said second disc recliner;
wherein selectively actuating said first and second disc recliners between said locked and unlocked conditions with said seat back coupled with said first and second disc recliners allows pivotal adjustment of said seat back between said plurality of reclined seating positions, and wherein uncoupling said seat back with said first and second disc recliners allows pivotal adjustment of said seat back between a selected one of said plurality of reclined seating positions and said forwardly folded position.

16. A recliner assembly as set forth in claim 15 wherein said first and second coupling mechanisms automatically re-couple said seat back and said first and second disc recliners in response to returning said seat back from said forwardly folded position to said selected one of said plurality of reclined seating positions.

17. A recliner assembly as set forth in claim 16 wherein said first and second disc recliners are directly coupled together and actuation of said second disc recliner from said locked condition to said unlocked condition simultaneously actuates said first disc recliner from said locked condition to said unlocked condition.

18. A recliner assembly as set forth in claim 17 wherein said first coupling mechanism includes a first cam and a first stop pin coupled to said seat back and a first sector coupled to said first disc recliner, said second coupling mechanism includes a second cam and a second stop pin coupled to said seat back and a second sector coupled to said second disc recliner, wherein said first cam and said first stop pin engage with said first sector and said second cam and said second stop pin engage with said second sector thereby coupling said seat back and said first and second disc recliners, and wherein said first and second cams are operable to partially disengage with said first and second sectors thereby uncoupling said seat back and said first and second disc recliners.

19. A recliner assembly as set forth in claim 18 further including a first cable operatively coupled to said first cam for pivoting said first cam to partially disengage with said first sector and a second cable operatively coupled to said second cam for pivoting said second cam to partially disengage with said second sector thereby uncoupling said seat back and said first and second disc recliners while maintaining said first and second disc recliners in said locked condition.
